(19) United States
(12) Patent Application Publication
(10) Pub. No.: US 2002/0049597 A1
(43) Pub. Date: Apr. 25, 2002

(54) Audio recognition method and device for sequence of numbers

(75) Inventor: Fumio Tamura, Saitama (JP)

Correspondence Address: MORGAN LEWIS & BOCKIUS LLP, 1111 PENNSYLVANIA AVENUE NW, WASHINGTON, DC, 20004, US

(73) Assignee: PIONEER CORPORATION

(21) Appl. No.: 09/940,584

(22) Filed: Aug. 29, 2001

(30) Foreign Application Priority Data
Aug. 31, 2000 (JP) P. 2000-264127

(51) Int. Cl. G10L 21/00

(52) U.S. Cl. 704/275

(57) ABSTRACT

There are provided voice recognition dictionaries divided respectively so as to meet a plurality of regions of a sequence of numbers which are separate in view of meaning and a continuous voice recognition means for connecting a plurality of voice recognition dictionaries together in accordance with an input voice pattern to recognize the input voice pattern. A recognition dictionary creating section 7 dynamically connects a recognition dictionary composed of all existing suburb code numbers, a recognition dictionary composed of the combined numbers of the suburb code numbers and city code numbers corresponding thereto and a subscriber recognition dictionary together in accordance with the input voice pattern to supply the input voice pattern to a voice recognition section 4 and recognize an inputted voice.

### BACKGROUND OF THE INVENTION

1. Field of the Invention

The present invention relates to an audio recognition method and device for a sequence of numbers preferably employed for an audio recognition of a telephone number or a postal code in which a plurality of sets of numeric characters are connected together to have a proper meaning.

2. Description of the Related Art

A telephone number dialing device or a telephone number search device by a voice has been put to practical use. However, the numeric caracters are heretofore treated as a simply continuous sequence of numbers when they are recognized, and then, it is decided whether or not they constitute a suitable telephone number after the numeric character are completely inputted.

In this case, all numbers can be asserted by speaking once and a number inputting process can be advantageoulsy rapidly carried out. However, suburb code numbers or the combinations of suburb code numbers and city code numbers which do not exist may be erroneously recognized.

A communication procedure between a system and a user is performed as described below.

Guidance message: “please speak a telephone number”

Speaking: “0492851111”

Recognition result: “0492151111” (not exist)

Message: “number is not registered”

As another example, there has been also provided a device that a sequence of numbers is recognized by dividing it into a plurality of parts such as a suburb code number, a city code number and a subscriber's number in accordance with meaning. In this case, since an exclusively used recognition dictionary can be used for each separation, the numbers which do not exist are not obtained as the recognition result, however, a plurality of times of recognition processes need to be done so that much time and labor are required.

A communication procedure between the system and the user in this case is described below.

Guidance message: “please speak a suburb code number”

Speaking: “0492”

Recognition result: “0492”

Guidance message: “please speak a city telephone”

Speaking: “85”

Recognition result: “85”

Guidance message: “please speak the rest of numbers”

Speaking: “1111”

Recognition result: “1111”

In order to recognize all the numbers simultaneously and recognize only proper numbers, a waiting dictionary including the combinations of all the numbers needs to be prepared, which is actually impossible.

As described above, according to the conventional telephone number recognition devices by voice, although an input operation is not troublesome, illegal numbers are inconveniently received in the former. On the other hand, although the illegal numbers are not accepted, a telephone number need be divided into a plurality of parts and the divided parts inconveniently need be spoken in order with much time and labor in the latter.

### SUMMARY OF THE INVENTION

The present invention is made by considering the above mentioned circumstances. It is an object of the present invention to provide an audio recognition device and method for a sequence of numbers that a sequence of numbers having a plurality of regions separate in view of meaning is divided into a plurality of regions and voice recognition dictionaries divided respectively for the divided regions are connected together to continuously perform an audio recognition so that all numbers can be completely inputted by speaking once and illegal numbers are not accepted in suburb code numbers and city code numbers.

In order to solve the above mentioned problems, according to an audio recognition method for a sequence of numbers of the present invention, voice recognition dictionaries divided to meet a plurality of regions of a sequence of numbers having a plurality of regions separated in view of meaning are connected together to continuously carry out a voice recognition.

Here, the sequence of numbers designates, for instance, a telephone number composed of 10 digits. The sequence of numbers comprises regions separate in meaning such as a suburb code number region, a city code number region and a subscriber's number region. These regions different in view of meaning are connected together to form one telephone number.

Further, according to the audio recognition method of the present invention, the sequence of numbers is a telephone number including a suburb code number, a city code number and a subscriber's number as the regions.

Further, according to the audio recognition method of the invention, the sequence of numbers is a postal code including a city number, a ward number and an area number as the regions.

According to the invention, an audio recognition device for a sequence of numbers comprises a plurality of voice recognition dictionaries provided for respectively divided regions which are obtained by dividing a sequence of numbers into a plurality of regions separate in view of meaning; and continuous voice recognition means for connecting the plurality of voice recognition dictionaries together in accordance with an input voice pattern to recognize it.

Further, the audio recognition device is characterized in that the voice recognition dictionary includes a recognition dictionary composed of all existing suburb code numbers, a recognition dictionary composed of the combined numbers of the suburb code numbers and city code numbers corresponding to the suburb code numbers and a subscriber recognition dictionary and the respective dictionaries are dynamically connected together in accordance with the input voice pattern to supply the input voice pattern to the continuous voice recognition means.

Still further, according to the audio recognition device of the present invention, as the voice recognition dictionary, the audio recognition device further comprises a suburb code number ID table in which each entry is composed of a city code number corresponding to a suburb code number and city code number data can be obtained by designating a suburb code number ID.

According to the above described constitution, since the recognition of a telephone number is carried out by limiting it only to existing suburb code numbers and existing city code numbers, illegal suburb code numbers and city code numbers are not erroneously recognized so that a recognition rate is improved. Further, the telephone number can be completely inputted by speaking once, and accordingly, the telephone number can be efficiently inputted.

### BRIEF DESCRIPTION OF THE DRAWINGS

FIG. 1 is a block diagrams showing an embodiment of an audio recognition method and device for a sequence of numbers according to the present invention.

FIG. 2 is a diagram showing one example of a recognition dictionary stored in a recognition dictionary memory shown in FIG. 1.

FIG. 3 is a diagram showing one example of a recognition dictionary stored in the recognition dictionary memory shown in FIG. 1.

FIG. 4 is a diagram showing one example of a recognition dictionary stored the recognition dictionary memory shown in FIG. 1.

FIG. 5 is a diagram showing one example of a recognition dictionary stored in the recognition dictionary memory shown in FIG. 1.

FIG. 6 is a diagram showing one example of a city code number ID table stored in a suburb-city number combination memory shown in FIG. 1.

FIG. 7 is a diagram showing one example of a network construction for continuously recognizing a plurality of recognition dictionaries transferred to a recognition dictionary storing section shown in FIG. 1.

FIG. 8 is a diagram showing one example of a network construction for continuously recognizing a plurality of recognition dictionaries transferred to the recognition dictionary storing section shown in FIG. 1.

FIG. 9 is a diagram showing one example of a network construction for recognizing a recognition dictionary transferred to the recognition dictionary storing section shown in FIG. 1.

FIG. 10 is a flowchart referred to for explaining the operation of the embodiment of the present invention.

FIG. 11 is a flowchart referred to for explaining the operation of the embodiment of the present invention.

### DETAILED DESCRIPTION OF THE PRESENT INVENTION

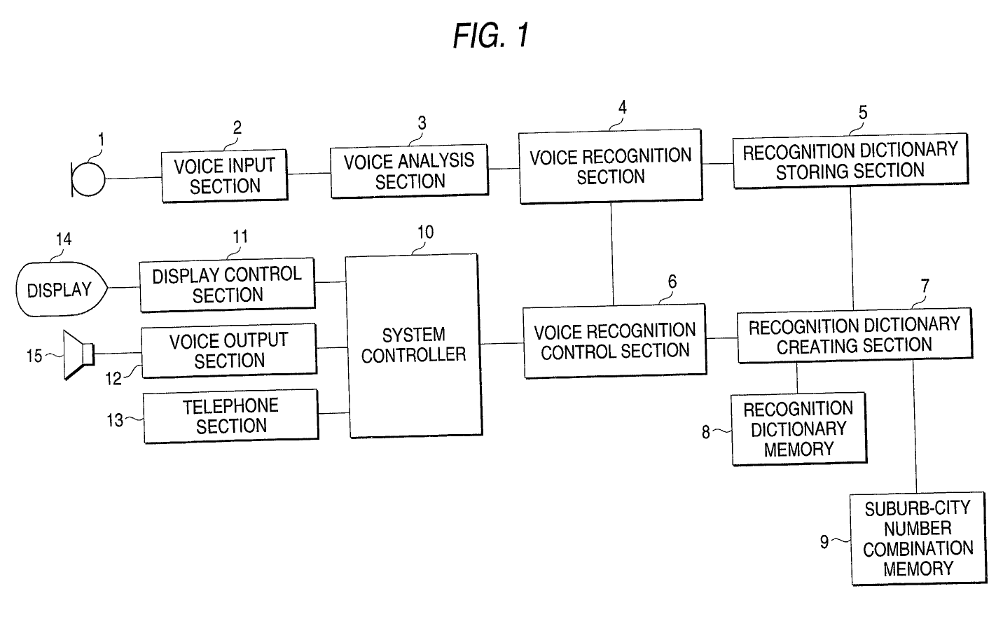

FIG. 1 is a block diagram showing an embodiment of an audio recognition device for a sequence of numbers according to the present invention. In FIG. 1, a reference numeral 1 denotes a microphone for converting the voice of a user into an electric signal. A reference numeral 2 denotes a voice input section for amplifying the voice converted to the electric signal to a desired level. A reference numeral 3 designates a voice analysis section for analyzing an inputted audio signal and for generating audio feature parameters. A reference numeral 5 denotes a recognition dictionary storing section in which word parameters to be subjected to a matching process in a voice recognition are stored. A reference numeral 4 denotes a voice recognition section for carrying out a voice recognition by computing the similarity between the audio feature parameters analyzed in the voice analysis section 3 and the word parameters stored in the recognition dictionary storing section 5.

A recognized result of a voice uttered by the user is supplied to a voice recognition control section 6 as a recognized word. The voice recognition control section 6 changes the structure of the voice recognition dictionary of the recognition dictionary storing section 5 and transmits a final recognition result of a sequence of numbers to a system controller 10. A recognition dictionary creating section 7 takes out a required recognition dictionary from a recognition dictionary memory 8 in accordance with an instruction from the voice recognition control section 6 and transfers the required recognition dictionary to the recognition dictionary storing section 5 as the recognition dictionary. The system controller 10 performs the display of a recognition result to a display 14 through a display control section 11, the input of a voice and a telephone transmitting process to a telephone section 13, or the like on the basis of the voice recognition result obtained from the voice recognition control section 6. Reference numeral 9 denotes a suburb-city number combination memory in which a suburb code number ID table for storing the associated information of a suburb code number and a city code number ID is stored and the details thereof will be described by referring to FIG. 6.

Reference numeral 12 denotes a voice output section for outputting the above described guidance messages or the recognition results by voice and the voice output section serves to output a necessary voice messages in accordance with the instruction of the system controller 10.

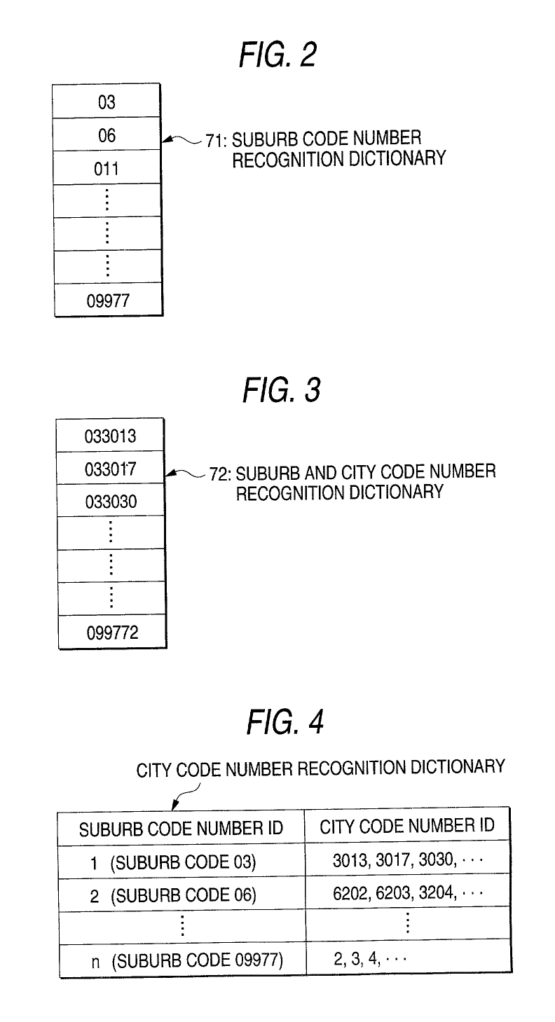

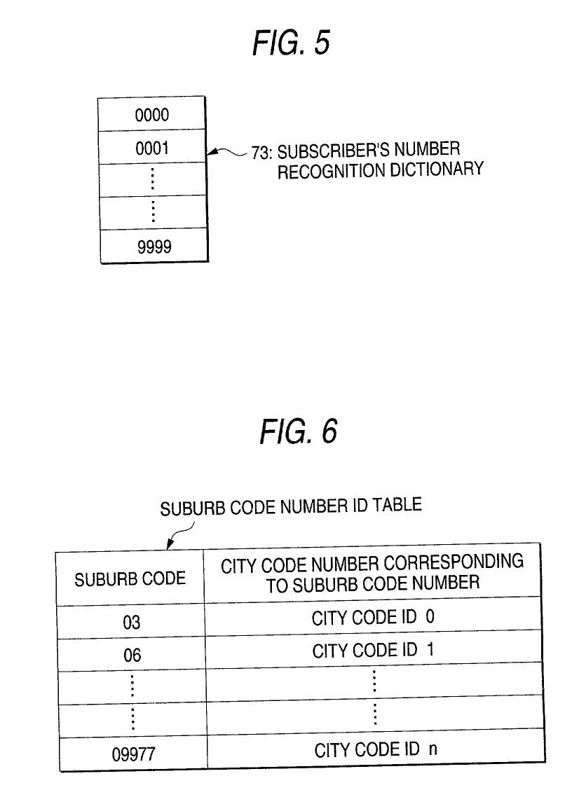

FIGS. 2 to 6 show recognition dictionaries stored in the recognition dictionary memory 8. A suburb number recognition dictionary 71 shown in FIG. 2 is a recognition dictionary composed of all existing suburb code numbers. A suburb and city code number recognition dictionary 72 shown in FIG. 3 is a recognition dictionary including the combined numbers of suburb code numbers and city code numbers corresponding thereto. A city code number recognition dictionary shown in FIG. 4 is a dictionary that each entry is composed only of city code numbers corresponding to suburb code numbers, so that city code number data can be obtained by designating a suburb code number ID. A subscriber number recognition dictionary 73 shown in FIG. 5 is a dictionary for recognizing four digit numeric characters ranging from “0000” to “9999”.

FIG. 6 is a suburb code number ID table for storing the associated information of the suburb code numbers and city code number Ids. The suburb code number ID table is stored in the suburb-city number combination memory 9.

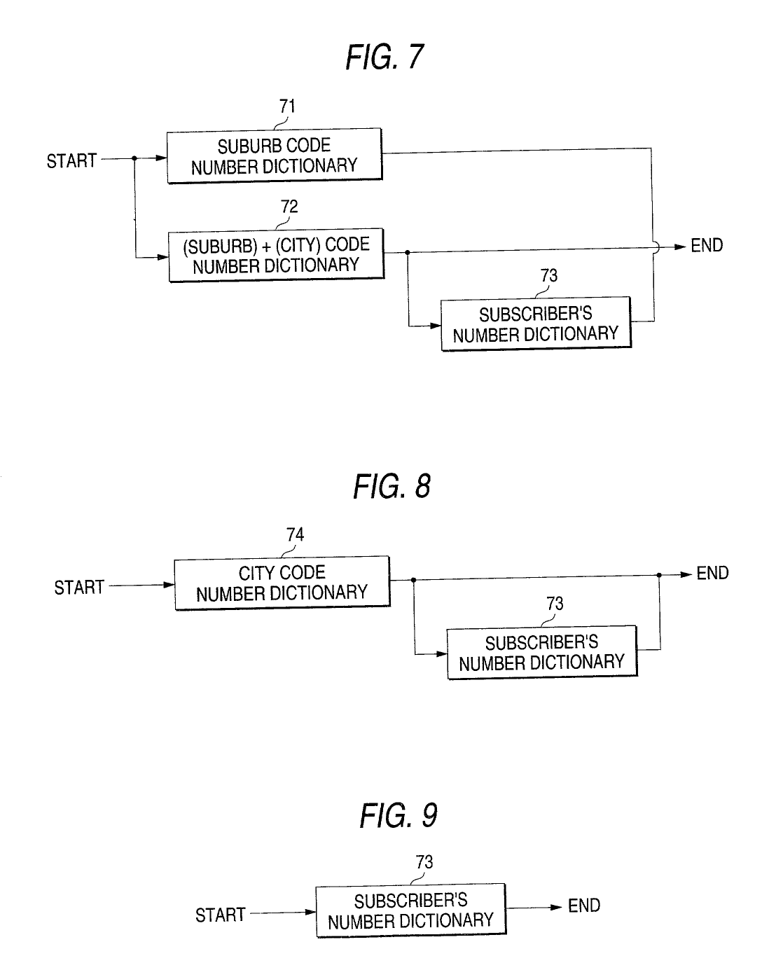

FIGS. 7 to 9 show a network construction for continuous recognition, using a plurality of recognition dictionaries transferred to the recognition dictionary storing section 5.

In the network construction shown in FIG. 7, the speech patterns of a suburb code number; a suburb code number and a city code number; and a suburb code number, a city code number and a subscriber's number can be received. When only the suburb code number is pronounced, a route from a start to an end via the suburb code number recognition dictionary 71 is traced to determine a suburb code number. When the suburb and city code numbers are pronounced, a route from the start to the end via the suburb and city code number recognition dictionary 72 is traced to determine the suburb + city code number. When the suburb code number, the city code number and the subscriber's number are pronounced, a route from the start to the end via the suburb and city code number recognition dictionary 72 and the subscriber number recognition dictionary 73 is traced to determine the suburb + city + number.

In the network construction illustrated in FIG. 8, the speech patterns of the city code number, and the city code number and the subscriber's number can be received. When only the city code number is pronounced, a route from a start to an end via a city code number recognition dictionary 74, explained later, is traced to determine the city code number. When the city code number and the subscriber's number are pronounced, a route from the start to the end via the recognition dictionary 74 and the subscriber number recognition dictionary 73 is traced to determine the city + subscriber's number. In the network construction shown in FIG. 9, only the speech pattern of the subscriber number can be recorded. When only the subscriber's number is pronounced, only the subscriber's number recognition dictionary 73 is traced.

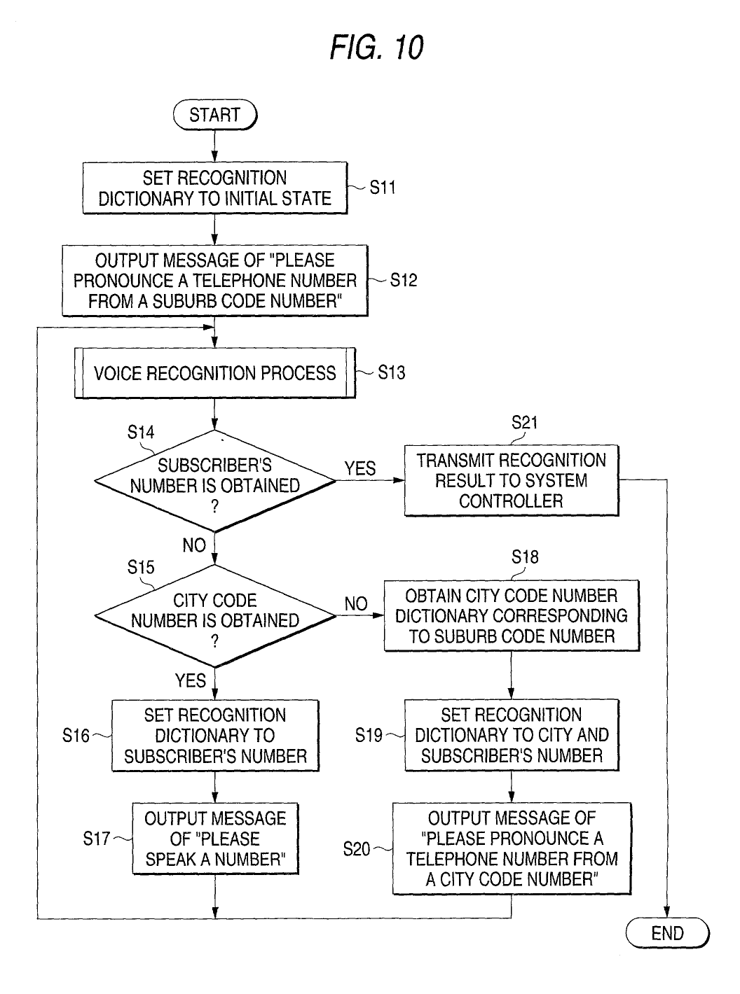

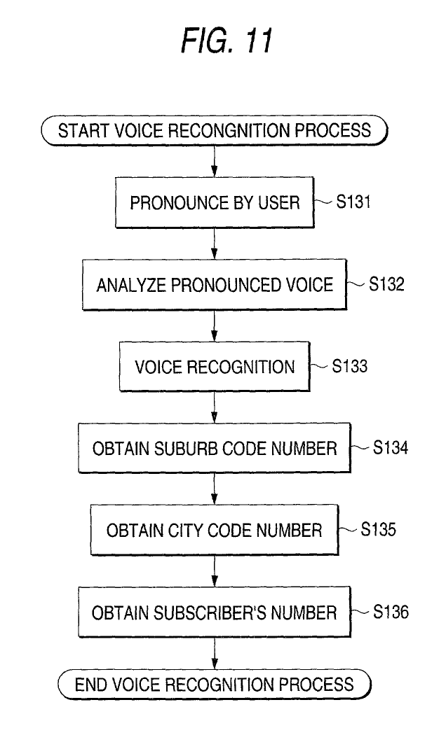

Now, in accordance with flowcharts shown in FIGS. 10 and 11, the operation of the embodiment of the present invention shown in FIGS. 1 to 9 will be described in detail.

Initially, referring to the flowchart shown in FIG. 10, a telephone number recognition processing will be described. When the telephone number recognition processing is started, the respecitve recognition dictionaries (71 to 73) including the suburb code number dictionary, the suburb + city code number dictionary and the subscriber's number are transferred to the recognition dictionary storing section 5 from the recognition dictionary memory 8 in step S11 to form the network construction of the recognition dictionaries, as shown in FIG. 7. When the setting process of the recognition dictionaries is completed, a guidance message of “please pronounce a telephone number from a suburb code number ” is outputted to urge a user to pronouce the telephone number in step S12. Then, a voice is recognized in step S13.

Subsequently, it is judged whether or not the recognition result up to the subscriber's number is got in step S14. In the embodiment of the present invention, it can be judged that all numbers are got when the subscriber's number is obtained, because the suburb, city and subscriber's numbers are recognized in order, or recognized at the same time. When the recognition result up to the subscriber's number is obtained, the system controller 10 is informed of the recognition result as the recognition results of all the obtained sequences of telephone numbers. The controller 10 finishes the telephone number recognition process. When the recognition result up to the subscriber's number is not obtained, step S15 is executed in order to get numbers of insufficient parts.

In the step S15, when the city code number is obtained, which means both the suburb and city code numbers are correctly recognized, the step S15 of the procedure moves to step S16, since only the subscriber's number may need to be got. On the other hand, when the city code number is not obtained in the step S15, which means only the suburb number is correctly recognized, the procedure moves to a process of step S18 for obtaining the city code number and the subscriber's number. In the step S16, the dictionary network of the recognition dictionary storing section 5 is changed to a form shown in FIG. 9 so that only the subscriber's number can be recognized. Then, in the step S16, after a guidance message of “please speak a number” is outputted, the process of the procedure shifts to the recognition process in the step S13.

To obtain the city code number and the subscriber's number are obtained. In the step S18, the suburb code number ID table shown in FIG. 6 is referred to transfer a city code number dictionary 74, corresponding to the obtained and recognized suburb code number, to the recognition dictionary storing section 5. In step S19, the dictionary network of the recognition dictionary storing section 5 is changed to a form shown in FIG. 8 so as to recognize the city code number and the city code number and the subscriber's number. Then, in step S20, after a guidance message of “please pronounce a telephone number from a city code number” is outputted, the process of the procedure moves back to the recognition process of the step S13.

The recognition process is specifically illustrated in FIG. 11. Initially, in step 132, a pronounced voice (step S131) is analyzed to obtain an audio feature parameter. Then, the similarity between the analyzed audio feature parameter and all words in the recognition dictionaries stored in the recognition dictionary storing section 5 is obtained in step S133. The similarity is acquired by considering the above described network construction. Thus, the route having the highest similarity and the recognized word are got as the recognition result. In steps S134 to 136, the suburb code number, the city code number, and the subscriber's number are obtained from the recognition result.

In the embodiment of the present invention, although only telephone numbers are exemplified, it is to be understood that the invention may be applied to all of a plurality of sets of numeric characters which are connected to have meanings. For instance, the invention may be similarly applied to a postal code composed of a city and ward number of 3 digits and an area number of 4 digits.

As described above, according to the present invention, the voice recognition of a sequence of numbers having a plurality of regions separate in view of meaning is continuously carried out by connecting voice recognition dictionaries divided respectively so as to meet the plurality of regions of the sequence of numbers. Since the telephone number is recognized by limiting it to the existing suburb code numbers and the existing city code numbers, the illegal suburb and city code numbers are not erroneously recognized. Therefore, to improve the recognition rate is accomplished. Further, the telephone number can be completely inputted by pronouncing it once in a lump so that the telephone number can be efficiently inputted.

What is claimed is:

1. An audio recognition method for a sequence of numbers having a plurality of regions dividable in meaning, comprising the steps of:
connecting a plurality of voice recognition dictionaries with each other, the plurality of voice recognition dictionaries corresponding to the plurality of regions, respectively; and
continuously carrying out an audio recognition.

2. The audio recognition method according to claim 1, wherein the sequence of numbers is a telephone number including a suburb code number, a city code number and a subscriber's number as the regions.

3. The recognition method according to claim 1, wherein the sequence of numbers is a postal code including a city number, a ward number and an area number as the regions.

4. An audio recognition method for a sequence of numbers having a first, second and third regions different in meaning from each other, the audio recognition method comprising the steps of:
preparing a first, second and third dictionaries;
receiving a sequence of numbers pronounced by voice;
analyzing the sequence of numbers pronounced by voice with reference to the first, second and third dictionaries to determine the successful recognition of the first, second and the third region in order;
a) unless the third region is successfully recognized,
preparing the third dictionary,
receiving the third region in the sequence of the numbers pronounced by voice, and
analyzing the third region therein with reference to the third dictionary; and
b) unless the second and third regions are recognized,
preparing the second and third dictionaries;
receiving the second and third regions in the sequence of the numbers pronounced by voice, and
analyzing the second and third regions with reference to the second and third dictionary.

5. The audio recognition method according to claim 4, wherein
the first dictionary corresponds to the first region;
the second dictionary corresponds to the second region depending on the first region; and
the third dictionary corresponds to the third region.

6. The audio recognition method according to claim 4, wherein the sequence of the number is a telephone number and;
the first, second and third regions in the sequence of numbers correspond to a suburb code number, a city code number corresponding to the suburb code number, and a subscriber's number, respectively.

7. The audio recognition method according to claim 4, wherein the sequence of the number is a postal code; and
the first, second and third regions in the sequence of numbers correspond to a city number, a ward number corresponding to the city number, and an area number, respectively.

8. An audio recognition device for a sequence of numbers comprising:
a recognition dictionary memory, in which a plurality of voice recognition dictionaries for storing a plurality of numbers included in regions divided from a sequence of numbers in meaning are stored; and
a continuous voice recognition section for connecting the plurality of voice recognition dictionaries together, in accordance with an expected input voice pattern, to recognize the sequence of the number.

9. The audio recognition device for a sequence of numbers according to claim 8, wherein the recognition dictionary memory includes:
a first recognition dictionary containing suburb code numbers, and
a recognition dictionary containing combined numbers of suburb code numbers and city code numbers corresponding to the suburb code numbers; and
a subscriber recognition dictionary containing subscriber's numbers; and
wherein the respective dictionaries are dynamically connected together in accordance with the expected input voice pattern, in the continuous voice recognition section.

10. The audio recognition device according to claim 8, wherein the recognition dictionary memory comprises a suburb code number ID table having each entry containing a city code number corresponding to a suburb code number, the city code number is obtained by designating a suburb code number ID.

11. The audio recognition device according to claim 9, wherein the recognition dictionary memory comprises a suburb code number ID table having each entry containing a city code number corresponding to a suburb code number, the city code number is obtained by designating a suburb code number ID.

12. The audio recognition device according to claim 10, wherein the continuous voice recognition section creates a city code number dictionary by the city code number under designating the suburb code number ID.

13. The audio recognition device according to claim 11, wherein the continuous voice recognition section creates a city code number dictionary by the city code number under designating the suburb code number ID.

14. The audio recognition device according to claim 12, wherein the city code number dictionary and the subscriber recognition dictionary are connected together, in accordance wit hteh expected input voice pattern, in the continuous voice recognition section.

15. The audio recognition device according to claim 13, wherein the city code number dictionary and the subscriber recognition dictionary are connected together, in accordance wit hteh expected input voice pattern, in the continuous voice recognition section.
